(19) United States
(12) Patent Application Publication
(10) Pub. No.: US 2007/0182326 A1
(43) Pub. Date: Aug. 9, 2007

(54) Filament lamp comprising two coiled filaments and a lamp assembly

(75) Inventor: Cornelis Versluijs, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,797

(22) PCT Filed: Mar. 3, 2005
(86) PCT No.: PCT/IB05/50795

§ 371 Date: Sep. 12, 2006

(30) Foreign Application Priority Data
Mar. 17, 2004 (EP) 04101098.4

(51) Int. Cl. H01J 17/04; H01K 1/50

(52) U.S. Cl. 313/578; 313/628

(57) ABSTRACT

A filament lamp comprising a sealed transparent vessel (1) containing at least two coiled filaments (3,4) and conductive means (5,6,7;8,9,10;11,12,13) for supplying electric power to each of the at least two coils (3,4). The coils (3,4) are positioned coaxially, and has different diameters. At least a portion of the coil (3) having the larger diameter surrounds at least a portion of the coil (4) having the smaller diameter.

The invention is related to a filament lamp comprising a sealed transparent vessel containing at least two coiled filaments and conductive means for supplying electric power to each of the at least two coils. Such a filament lamp, for use as headlamps for a motor vehicle, is disclosed in U.S. Pat. No. 4,140,939.

The light in such a filament lamp is generated by the coiled filament, i.e. a filament (wire) wound into a helical coil, hereinafter simply called a coil. A predetermined location of the light emitting coil in the transparent vessel of the lamp may be important, for example, when the light radiation has to be reflected by a reflector in order to create a predetermined beam of light radiation. The shape of the reflector as well as the location of the light emitting coil relative to the reflector determine the shape of the created light beam and the distribution of the intensity of the light in the light beam.

The location of the light emitting coil in the transparent vessel of the lamp is also important when a light beam is created by means of a lens. The light source has to be located exactly at a certain location in front of the lens in order to create the predetermined light beam.

There are different reasons for providing a filament lamp with more then one light emitting coil. For example, it may be required to create different light beams by means of the same light reflector. For that purpose more lamps can be present at different locations relative to the same reflector, whereby each lamp creates its own light beam by means of that reflector. However, the two light sources can also be combined in one lamp, whereby the vessel of the lamp contains two light emitting coils. Especially when the light beams are created by means of a relative small reflector, often the light sources has to be located close near each other, so that it is necessary to locate them in the same vessel. For example, such lamps are used as automotive head lamps.

A filament lamp can also be provided with two (or more) coils in order to create the possibility of having different light intensities emitted by the same lamp. The two coils may have the same power capacity or different power capacities. In case the two coils have different power capacities, the lamp can emit three different light intensities: by making use of each of the two coils separately, and by combining the light emission of the two coils. For example, such lamp is known as combined back lamp and brake warning lamp of a motor vehicle.

An object of the invention is a filament lamp comprising a sealed transparent vessel containing at least two light sources, whereby two light sources can be located close to each other, or even at substantially the same location.

To accomplish that objective, two coils are positioned coaxially, whereby the two coils has different diameters, and whereby at least a portion of the coil having the larger diameter surrounds at least a portion of the coil having the smaller diameter. When the two coils have the same length and the coil having the larger diameter surrounds the coil having the smaller diameter completely, then the two light sources, i.e. the centres of the two coils, are located at the same place in the vessel of the lamp.

In one preferred embodiment, the vessel has a tube-like shape, whereby the means for supplying electric power to the coils comprise feed through poles at one end of the tube-like vessel, and whereby the two coils are substantial coaxial with respect to the tube-like vessel. Thereby a rotational symmetric lamp can be obtained, which lamp can be used for producing a light beam having a round cross section by making us of a rotational symmetric reflector. The diameter of the light beam at a certain distance from the lamp can be changed by changing the location of the light source in the lamp in axial direction. So, in case the two light emitting coils of the lamp overlap each other only partly, the two coils can produce light beams having a different shape. And the two coils together can produce a rotational symmetric light beam being having a larger light intensity.

The two light emitting coils may have the same power capacity or may have different power capacities. In general, the power capacity of the light emitting coil is dependent on several parameters, including the length and the thickness (diameter) of the helically coiled filament. A larger power capacity of the coil requires a longer filament having a larger thickness. When such longer filament is wound into a coil having a larger diameter, the length of the coil will be shorter than when the same filament is wound into a coil having a smaller diameter. Therefore, preferably, the filament forming the coil having the larger diameter has a larger thickness than the filament forming the coil having the smaller diameter.

In one preferred embodiment, the coil having the smaller diameter is longer then the coil having the larger diameter, so that only a part of the coil having the smaller diameter is surrounded by the coil having the larger diameter. Thereby, preferably, the coil having the larger diameter surrounds one end of the coil having the smaller diameter over a length equal to the length of the coil having the larger diameter. So, at one end the coils are positioned in the same radial plane, and at the other end the coil having the smaller diameter extends further than the coil having the larger diameter. Preferably, said one end is the end of the coils directed to the end of the lamp where the conductive means for supplying electric power to each of the at least two coils are located.

Preferably, the lamp is a halogen lamp, and preferably the filament is a tungsten wire.

The invention is furthermore related to a lamp assembly comprising a filament lamp and a reflector for producing a diverging beam of light radiation, whereby the filament lamp comprises a sealed transparent vessel containing a coiled filament and conductive means for supplying electric power to the coil, whereby the transparent vessel contains two coils, both positioned coaxially with respect to the reflector, and whereby the two coils has different diameters, and whereby at least a portion of the coil having the larger diameter surrounds at least a portion of the coil having the smaller diameter.

Such lamp assembly is preferably a non-detachable unit that can produce a diverging light beam having a round cross section. Because the locations of the coils are different, each coil can produce a light beam having a different degree of divergence. So, two different light beams can be obtained by supplying electric power to the two coils separately. When electric power is supplied to both coils, a much brighter light beam is obtained.

The lamp assembly can be used in cases where two or more different light intensities are required, and/or in cases where light beams having different degrees of divergence are required. The lamp assembly can be composed of different parts that are detachably connected to each other, but preferably the lamp assembly is an integrated unit.

In order to elucidate the invention, an embodiment of a double filament halogen lamp, and an embodiment of a lamp assembly, will be described, referring to the drawing, in which

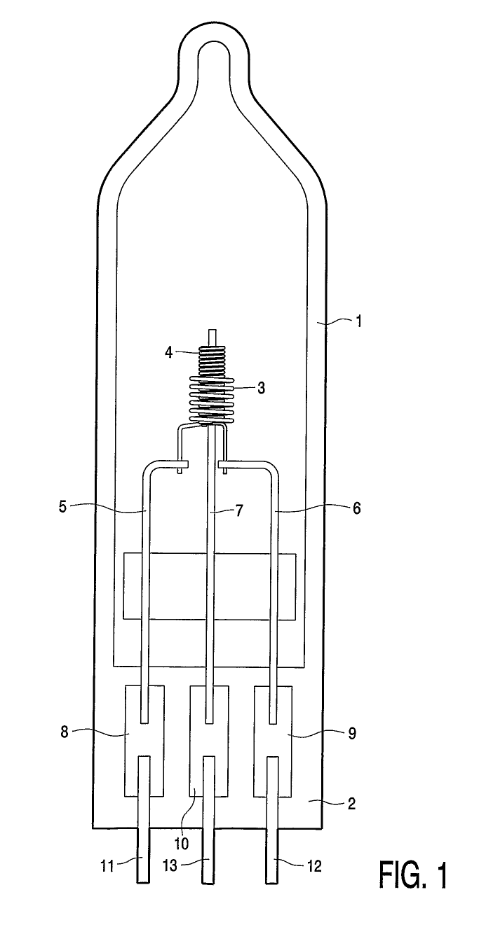

FIG. 1 is a diagrammatic sectional view of the lamp;

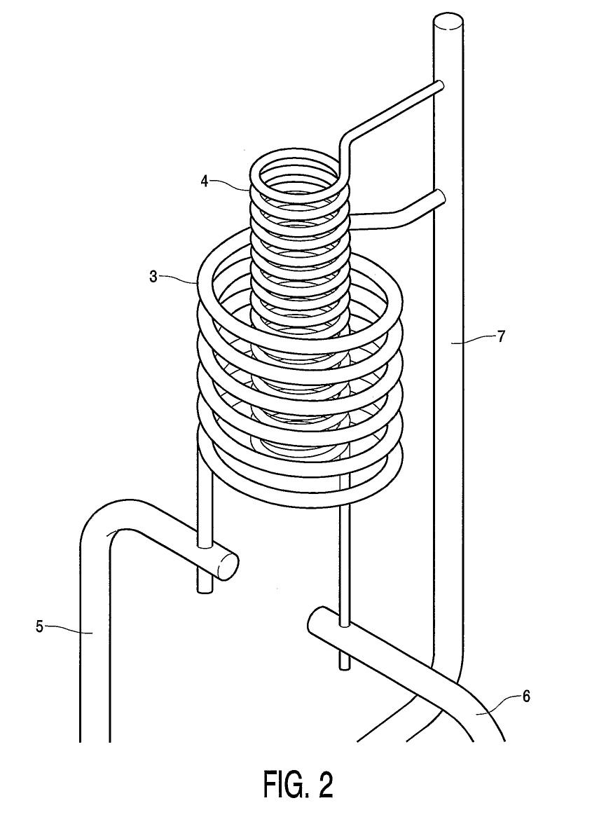

FIG. 2 is a diagrammatic perspective view of the coils of the lamp; and

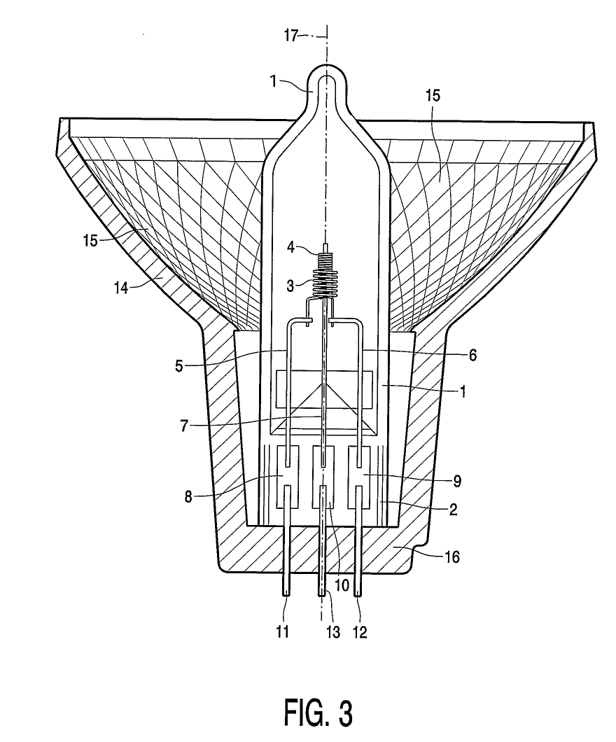

FIG. 3 is a diagrammatic sectional view of a lamp assembly.

In both embodiments, similar parts are indicated with the same numerals.

FIG. 1 shows a filament halogen lamp comprising a sealed tube like transparent vessel 1. The vessel 1 is made of quartz or hard-glass and has a seal 2 at its lower end. The vessel 1 comprises two light sources, namely a first coil 3 having a larger diameter, and a second coil 4 having a smaller diameter. Both coils 3,4 are made of a tungsten wire and they are positioned coaxial with the axis (centre line) of the tube-like vessel 1.

FIG. 2 shows the position of the first coil 3 and the position of the second coil 4 in more detail. The lower ends of both coils 3,4 are located in the same radial plane. Because the second coil 4 is longer than the first coil 3, the second coil 4 extends further in the upward direction than the first coil 3. The conductor wire 5 is connected with the lower end of first coil 3 and the conductor wire 6 is connected with the lower end of the second coil 4. The conductor wire 7 is connected with the higher end of the first coil 3 as well as the higher end of the second coil 4.

As shown in FIG. 1, tube like vessel 1 is sealed at its lower end with a seal 2. The seal 2 comprises three feed through poles 8,9,10, whereby each feed through pole connects a conductor wire 5,6,7, with an external contact pin 11,12,13. Thereby contact pin 11 is connected with conductor wire 5 through pole 8, and contact pin 12 is connected with conductor wire 6 through pole 9, and contact pin 13 is connected with conductor wire 7 through pole 10. Electric power can be supplied to the light emitting coils 3,4 by these conductive means.

It will be clear that the first coil 3 can be energized by supplying electric power through contact pins 11 and 13, and that the second coil 4 can be energized by supplying electric power through contact pins 12 and 13. So, each coil 3,4 can be provided with electric power separately, but it is also possible to provide both coils 3,4 at the same time with electric power, so that both coils 3,4 are emitting light at the same time.

FIG. 3 shows a lamp assembly comprising a substantial parabolic reflector 14 to produce a diverging light beam having a round sectional shape. The reflector can be made of plastic or other material and the substantial parabolic surface of the reflector is composed of a number of small flat surfaces 15 each being a flat mirror reflector. The transparent vessel 1 of the lamp is connected to the reflector 14 through its seal 2, at the bottom-part 16 of the reflector 14. Thereby the contact pins 11,12,13 are reaching through said bottom-part 16.

The axis 17 of the parabolic reflector 14 is coaxial with the axis (centre line) of the vessel 1 of the lamp. The light beam is directed in upward direction when the lamp assembly is in the position as represented in FIG. 3. Thereby, the light source 3,4 has to be located at the axis 17 (centre line) of the lamp. The degree of divergence of the light beam is determined by the location of the light source 3,4 on said axis 17. In the lamp assembly as shown in FIG. 3, the light source formed by the first coil 3 is at a lower location than the light source formed by the second coil 4. Therefore, the light emission from the first coil 3 will be reflected by reflector 14 into a more diverging light beam than the light emission from the second coil 4. However, because the two coils 3,4 are overlapping each other, the distance between the two light sources can be small, so that the two alternative light beams produced by the lamp assembly can have a small mutual difference in the degree of divergence.

In case the length of both coils 3,4 would be equal, the intensity of the light beam can be changed without varying the shape of the beam. Thereby three different intensities are possible, two different intensities by using each of the two coils 3,4, and a third intensity by making use of both coils 3,4 simultaneously.

The embodiments of the filament lamp and the lamp assembly as described above are only examples; a great many other embodiments are possible, including embodiments with other types of lamps.

1. A filament lamp comprising a sealed transparent vessel 1 containing at least two coiled filaments (3,4) and conductive means (5,6,7;8,9,10;11,12,13) for supplying electric power to each of the at least two coils (3,4), characterized in that two coils (3,4) are positioned coaxially, and in that the two coils (3,4) has different diameters, and in that at least a portion of the coil (3) having the larger diameter surrounds at least a portion of the coil (4) having the smaller diameter.

2. A filament lamp as claimed in claim 1, characterized in that the vessel (1) has a tube-like shape, whereby the means for supplying electric power to the coils (3,4) comprise feed through poles (8,9,10) at one end of the tube-like vessel (1), and whereby the two coils (3,4) are substantial coaxial with respect to the tube-like vessel (1).

3. A filament lamp as claimed in claim 1, characterized in that the filament forming the coil (3) having the larger diameter has a larger thickness than the filament forming the coil (4) having the smaller diameter.

4. A filament lamp as claimed in claim 1, characterized in that the coil (4) having the smaller diameter is longer then the coil (3) having the larger diameter.

5. A filament lamp as claimed in claim 4, characterized in that the coil (3) having the larger diameter surrounds one end of the coil (4) having the smaller diameter over a length equal to the length of the coil (3) having the larger diameter.

6. A filament lamp as claimed in claim 1, characterized in that it is a halogen lamp.

7. A lamp assembly comprising a filament lamp (1,2) and a reflector (14) for producing a diverging beam of light radiation, whereby the filament lamp comprises a sealed transparent vessel (1) containing a coiled filament and conductive means (5,6,7;8,9,10;11,12,13) for supplying electric power to the coil, characterized in that the transparent vessel (1) contains two coils (3,4), both positioned coaxially with respect to the reflector (14), and in that the two coils (3,4) has different diameters, and in that at least a portion of the coil (3) having the larger diameter surrounds at least a portion of the coil (4) having the smaller diameter.

8. A lamp assembly as claimed in claim 7, characterized in that the reflector (14) is a substantially parabolic reflector.
